(19) United States
(12) Patent Application Publication
(10) Pub. No.: US 2011/0320273 A1
(43) Pub. Date: Dec. 29, 2011

(54) SERVING CONTENT BASED ON CONVERSATIONS

(75) Inventor: Jose Emmanuel Miranda-Steiner, Redmond, WA (US)

(73) Assignee: MICROSOFT CORPORATION, Redmond, WA (US)

(21) Appl. No.: 12/823,096

(22) Filed: Jun. 24, 2010

(51) Int. Cl. G06Q 30/00

(52) U.S. Cl. 705/14.49

(57) ABSTRACT

Keywords may be extracted from conversations, such as Instant Messaging (IM) conversations, and content may be served based on the extracted keywords. In one example, an analysis component runs on a machine alongside a conversation application, such as an IM client. The analysis component compares words in the conversation with a dictionary of keywords. When keywords are detected, the keywords are sent to a server. Analysis components also run on other machines that participate in the conversation and, likewise, send keywords to the server. The server selects ads based on the detected keywords, and provides the ads to the machines that the participants are using to participate in the conversation, so that the ads can be displayed to the participants. The ads may be synchronized, so that all of the participants see the same ad impressions (or similar or related ad impressions).

### BACKGROUND

The success of electronic advertising often depends on the extent to which an ad impression matches the interest of its target. Historically, commercials shown during a television program were chosen to match the presumed interest of the program's target audience. When advertising is tied to search engines or e-mail systems, it is possible to target an ad even more precisely to a particular viewer's interest. In search engines, ads are chosen based on the search keywords, which can provide an accurate sense of what the searcher is interested in. When advertising is presented with e-mail (e.g., as part of a web mail system), the ads may be chosen based on keywords that appear in the e-mail, which can provide an accurate sense of what the sender and recipient of the e-mail are interested in. (To respect the privacy of users' e-mail communications and to allow users to make informed choices about the use of their mail, users of mail services may be informed of the mail service's privacy policy. That policy typically informs users of how ads may be targeted based on mail, and may also give users the option to opt-out of targeted ads.)

E-mail messages and search queries provide information about what ads a person might be interested in seeing. However, e-mail and search queries are only two such sources of information about what people are interested in. There are various other forms of information that may give clues about what types of ads a given person might respond to. These clues often arise in situations where a person would be receptive to ad impressions. However, many of these sources of information have not been used.

### SUMMARY

Ad impressions may be served to users in the context of instant message (IM) conversions, or other forms of real-time communication such as video chat, audio chat, etc. Communications between people often provide information about what a person is looking for. Some forms of communication (e.g., e-mail) may indicate what a person is interested in over a fairly long time horizon. For example, a person might use e-mail to talk about a restaurant that the person is planning to go to in the next week or month. However, people typically use IM to discuss things that they are interested in right now. Thus, the inference that a person would be interested in ads relating to the topic of an IM conversation is particularly compelling.

Therefore, IM conversations may be evaluated in real-time, and ads may be served to the participants of the IM conversations, based on keywords that occur in the IM conversation. A keyword extractor may evaluate IM conversations in order to identify certain keywords that appear in the conversations. (In order to ensure the privacy of participants in the conversation, extraction of keywords may be performed in accordance with an appropriate privacy policy. E.g., the participants may be given full disclosure about the use of keywords in advertising, and may be given the opportunity to opt out of the use of such keywords.)

Ads may be selected based on keywords extracted from a conversation. Impressions of those ads may be made to participants in the conversation. In one example, the ad impressions are synchronized, so that the various participants in a conversation see the same ads (or different versions of the same ads, or ads that are related even if they are not the same). By showing the same ads (or different versions of an ad, or related ads) to different participants in the conversation, participants are encouraged to talk about the subject of the ad, thereby potentially making the ad more effective. Ad impressions made during an IM conversation may have a particularly high impact, and the value of this impact may be taken into account when pricing placement of the ads.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example Instant Messaging (IM) conversation, in which advertising may be presented.

FIG. 2 is a block diagram of an example system in which ads may be selected and shown to a participant in a conversation.

FIG. 3 is a flow diagram of an example process in which ads may be displayed to participants in a conversation.

FIG. 4 is a block diagram of example components that may be used in connection with implementations of the subject matter described herein.

### DETAILED DESCRIPTION

As people spend increasing amounts of time on computers and computer-type devices, it becomes increasingly attractive for advertisers to find ways to reach people on those devices. Advertisers traditionally have been able to reach customers in certain kinds of print media (e.g., newspapers and periodicals) and on television. However, as technology changes, much time that people previously spent reading periodicals or watching television is now being spent on computers and smart phones. Modern computers and smart phones function as sources of information and entertainment. Moreover, the use of computers can replace voice calls in many contexts, since much information that used to be communicated in short, informal telephone calls is now communicated by e-mail, short message service (SMS) message, or Instant Messaging (IM). E.g., in the past, one might have called a friend on a wired telephone to say, “Let's meet downtown for dinner.” Today, this type of conversation often occurs by text message or IM.

The use of computers or computer-type devices to communicate makes it possible to target ads to people's interests. The targeting of ads has generally been based on search queries and e-mail. Targeting ads based on search queries and e-mail provides high value for advertisers, since both of these types of information reveal something about what the target of the ad might be interested in. For example, if a person searches on the query “restaurant Seattle,” then it is likely that the person is looking for a place to eat in Seattle. Ads from restaurants in Seattle can be served based on that query. Similarly, if a person sends an e-mail containing the word “relocation”, then it is possible that he is looking for a moving company, and ads can be served accordingly. (As noted above, targeting of ads based on e-mail may be done in accordance with an appropriate privacy policy, such as one that notifies the user of how mail contents will be used, and that allows the user to opt out of targeted ads.)

People express their interests differently in different contexts. The keywords that are mined from a person's search queries may have a relevance that is different from the same keywords mined from the same person's instant messages. When a person performs a search, he or she may be looking for something that is of general interest, or that is to be used sometime in the next week or month. Similarly, people send e-mail about things that will occur over various time horizons—e.g., one day, one week, one month, etc. However, the more informal types of communications, such as IM, are often used to communicate things that the user is interested in right now. For example, people who use both IM and e-mail may be more likely to choose IM to communicate thoughts such as, “Let's meet for dinner tonight,” or “let's meet at the movies tonight,” or other ideas that have some level of immediacy to them. This type of information is contextually different from search queries and e-mail, and thus may provide a particularly fertile ground for advertisers.

The subject matter described herein may be used to display ad impressions in IM communications, or various other types of communication. IM conversations, or other types of information, may be mined for keywords, and the keywords may be used to choose ads. When the content of a communication is available, that communication is compared with a dictionary of keywords. When communication is performed in a client/server architecture, the dictionary of keywords may be stored on the client, and the evaluation of the communication to determine what keywords are contained in the communication may be performed on the client. Once the keywords have been identified, those keywords may be uploaded to a server, which determines what ads to display. In one example, the ads may be synchronized among the various participants in a conversation. Thus, participant A's text might contain one set of keywords, and participant B's text might contain another set of keywords. Ads could be chosen based on both sets of keywords, and the same ads could be impressed to both participants. In another example, the same ads may be shown in different versions (e.g., a text-and-graphics version could be shown to a person on a computer, and a text-only version could be shown to a person on a phone). In another example, the ads that are shown are not the same, but would be related. E.g., if two people, in countries A and B, are talking about travel, then the person in country A could be shown ads for flights to country B, and the person in country B could be shown ads for flights in country A. Such ads could be considered synchronized, even though they are not the same ad.

The ads to be impressed could be chosen based on a keyword auction, or some other type of commercial mechanism. When an ad is selected for impression, the ad could be added to a queue, and ad impressions could be presented in the order in which they appear in the queue. As the topic of a conversation changes, new keywords might appear, thereby causing new ads to be chosen. When such new ads are chosen, they could be added to the queue, and could be displayed in turn when they come to the top of the queue.

While the techniques described herein may be applied to IM communications, they may also be used in other contexts such as video chat, audio chat, or any other circumstance in which keywords may be identified.

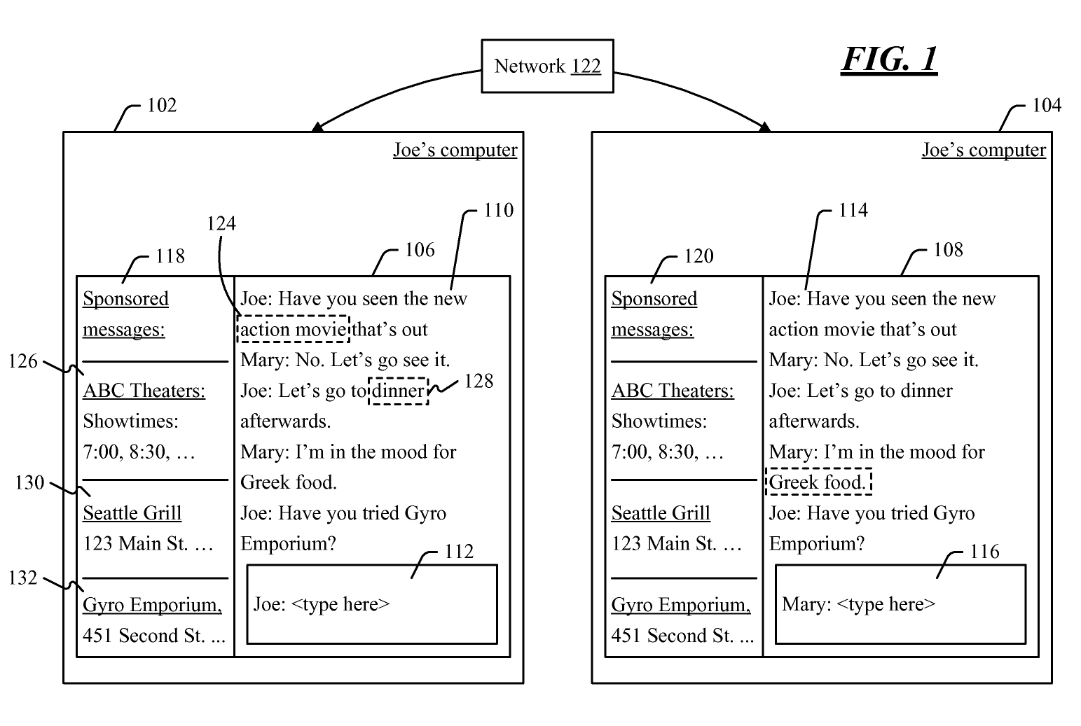

Turning now to the drawings, FIG. 1 shows an example of an IM conversation, in which advertising may be presented to participants in a conversation. The example conversation shown in FIG. 1 takes place between two people named Joe and Mary. However, an IM conversation could take place between any number of people. Joe and Mary participate in their conversations from their respective machines 102 and 104. Machines 102 and 104 may be any type of machines that have some computing and communication ability, such as a personal computer, a wireless telephone, a smart-phone, a WiFi-enabled music player, an Internet-enabled television, etc. (Machines 102 and 104 may be “distinct” from each other, in the sense that machine 102 is not the same machine as machine 104.) Communication between these machines may occur over network 122.

To participate in IM, each participant may have a chat window open. Thus, on Joe's machine 102, chat window 106 is open, and on Mary's machine chat window 108 is open. Joe's chat window has a history 110 containing text that has already been communicated in an IM session, and a text entry field 112 for typing new text. Likewise, Mary's computer has history 114 and text entry field 116. Additionally, the two chat windows have areas 118 and 120 in which advertisements may be displayed, which are labeled “sponsored messages” in FIG. 1.

The advertisements that are displayed in areas 118 and 120 may be displayed based on the contents of the messages exchanged between the participants. Areas 118 and 120 are inside Joe's and Mary's respective chat windows. (Displaying ads inside a chat window is an example of displaying ads together with conversation content, although there are other visual layouts in which an ad could be presented together with content.) For example, at some point during the IM session, Joe typed the phrase “action movie” (as indicated by numeral 124). This phrase may have been detected as an advertising keyword that has been purchased by a theater company. (As used herein, the term “keyword” may include a single word, a multi-word phrase, or any sequence of information such as numbers, symbols, etc.) Based on this keyword having been detected, an advertisement from that theater may be chosen, and an impression of that ad may be made. Thus, areas 118 and 120 both show an impression 126 for “ABC Theaters”. This impression names the theater (which, in this example, is the theater that bid on the keyword “action movie”), and the impression also lists show times for whatever action movie is currently playing. FIG. 1 shows an example in which both participants in the conversation are shown exactly the same ad. However, in another example, different versions of the ad could be shown to different participants—e.g., a text version on a cell phone, and a text-and-graphics version on a desktop or laptop computer. Or, if the participants are in different geographic locations, they could be shown different ads that are relevant to their respective geographic locations—e.g., they could be shown ads for movie theaters in different locations.

At a later point in the conversation, Joe enters the word “dinner” (as indicated by numeral 128). “Dinner” might be an advertising keyword that has been purchased regionally by several restaurants. It might be known (e.g., from the registration of Joe's IM account) that Joe is located in Seattle. Thus, based on Joe's location and based on the presence of the keyword “dinner” in the conversation, an impression 130 may be created for a particular Seattle-based restaurant, and impression 130 may be shown to both Joe and Mary. Similarly, at some point during the IM session, Mary may enter the phrase “Greek Food,” which may be detected as an advertising keyword. Based on this keyword (and possibly based on Mary's known location), an ad for a particular Greek restaurant may be chosen, and the corresponding impression 132 may be shown to both Joe and Mary.

One aspect of showing ads during an IM communication (or other real-time communication) is that the ad may spur conversation about the topic of the ad, which may be of value to the advertiser. For example, ad impression 132 is for the restaurant “Gyro Emporium.” After this ad is shown, Joe may be inspired to suggest that restaurant as part of the conversation, as shown in the last message in histories 110 and 114. Thus, Mary will see mention of Gyro Emporium, both in the form of ad impression 132, and in the form of a message from Joe. The value of ad impression 132 may have been increased, due to the fact that timely placement of the ad impression as part of an IM conversation inspired Joe to work the subject of the ad into the conversation.

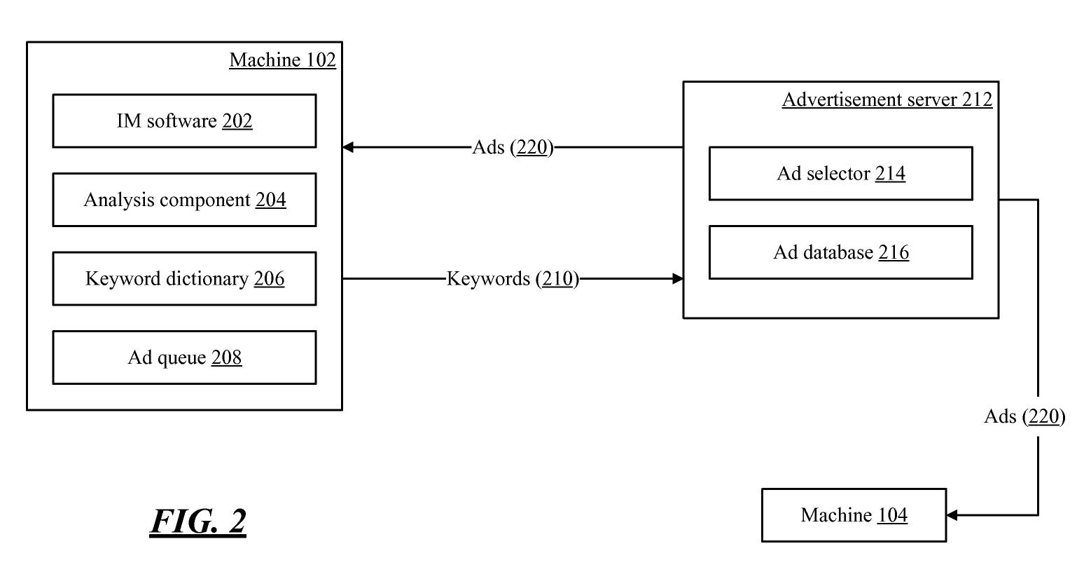

FIG. 2 shows an example system in which ads may be selected and shown to a participant in an IM conversation. As in FIG. 1, a conversation may take place between users of machines 102 and 104. Machine 102 has various components, such as IM software 202, an analysis component 204, a keyword dictionary 206, and an ad queue 208. Machine 104 may also have instances of these components.

IM software 202 is software that facilitates IM conversations. For example, IM software 202 may be a program that allows a user to open chat windows, to identify other users who are available for conversations, and to facilitate the sending and receiving of information between participants in a conversation. Additionally, IM software 202 may be configured to display ad impressions.

Analysis component 204 analyzes the content of conversations to detect the presence of keywords. Keyword dictionary 206 contains the keywords that analysis component 204 looks for in conversations. Thus, analysis component 204 may communicate with IM software 202 in order to analyze the conversations that are occurring through IM software 202. Analysis component may then compare the content of those conversations with terms in keyword dictionary 206. As noted above, the term “keyword”, as used herein, may include single words, multi-word phrases, or any other discernible sequence of information (e.g., numbers, symbols, etc.) that could occur in a conversation. The concept of a “keyword” is not limited to a single word.

When analysis component 204 detects one or more keywords 210 in a conversation, those keywords 210 are sent to advertisement server 212. (Advertisement server may be a computer that is remote from machine 102, and that is distinct from machine 102 in the sense that server 212 is not the same machine as machine 102.) Advertisement server 212 determines what ad impressions to generate based on the keywords that have been detected. Advertisement server 212 may comprise an ad selector 214, and an ad database 216. Ad database 216 contains a set of ads, indexed by keyword. The ads that appear in ad database 216 may have been placed in that database as a result of a commercial transaction, such as a keyword auction. Ad selector 214 compares keywords 210 with ad database 216 to determine what ads are to be shown to the participants in a conversation. For example, ad selector 214 may compare keywords 210 with an index of ad database 216 in order to determine which ads are associated with particular keywords.

It is noted that advertisement server 212 may be receiving keywords not only from machine 102, but also from machine 104, and from any other machine that people are using to participate in a conversation. That is, machine 104 may have its own instances of IM software, an analysis component, and a keyword dictionary, and may be using these components to generate keywords that are sent to advertisement server 212. When machine 104 sends keywords to advertisement server 212, ad selector 214 may select appropriate ads based on the keywords received from machine 104, and may send those ads 220 back to machine 104 to be displayed. Ad selector 214 may select ads to be displayed based on keywords received from any machine.

Ads may be synchronized across the participants in a conversation. One example way of synchronizing the ads is described as follows. When each machine that participates in a conversation sends keywords to advertisement server 212, that machine may also send the keywords to the other participants in the conversation. The sending of the keywords may occur through IM software 202. Thus, each participant in the conversation may receive, through the IM system, the keywords mined by other participants. When ads are served to a given participant, the given participant may also use the IM system to communicate, to the other participants, the identifiers of the ads that were served to that given participant. Thus, each participant in the conversation may receive the keywords mined by other participants, as well as the identifiers of the ads that were served to those participants. When a participant contacts advertisement server 212, that participant may send to the advertisement server the keywords mined by the participant, as well as the keywords and ad identifiers received from the other participants. The advertisement server 212 may then serve ads based on all of these keywords and identifiers. The advertisement server 212 uses the keywords and ad identifiers to decide what ads to serve, (although it may treat the keywords and ad identifiers differently when making that decision). Additionally, the actual ads that are served may be based on factors other than the keywords and ad identifiers received (e.g., given the same set of keywords and ad identifiers, different ads may be served based on the geographic location of a participant, as in the above example in which different participants are shown ads for different flights based on the country in which a participant is located.) Since the different participants use the IM system to share their keywords and ad identifiers with each other, the ads served to the different participants may tend to converge on the same ads (or similar ads, or related ads).

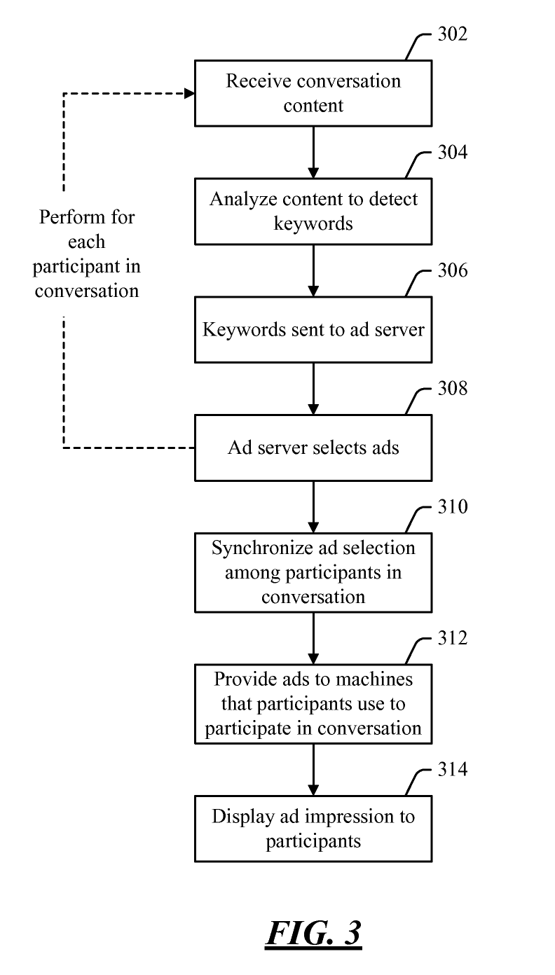

FIG. 3 shows an example process in which ads may be displayed to participants in an IM conversation (or other type of conversation). Before turning to a description of FIG. 3, it is noted that the flow diagram of FIG. 3 is described, by way of example, with reference to components shown in FIGS. 1 and 2, although this process may be carried out in any system and is not limited to the scenarios shown in FIGS. 1 and 2. Additionally, the flow diagram in FIG. 3 shows an example in which stages of a process are carried out in a particular order, as indicated by the lines connecting the blocks, but the various stages shown in FIG. 3 can be performed in any order, or in any combination or sub-combination.

At 302, conversation content may be received. For example, the conversation content may be received by the analysis component shown in FIG. 2, when that component examines the text of a conversation. At 304, the conversation content is analyzed to detect the presence of keywords in the conversation. Once the presence of keywords has been detected, at 306 the keywords may be sent to a server (e.g., to advertisement server 212, shown in FIG. 2). When the server receives the keywords, the server may select ads based on the keywords (at 308) (and also based on ad identifiers, as described above). As described above, the process of identifying keywords may take place on each participant's machine, so each participant's machine may be a source of keywords to be sent to the server. Thus, the stages at 302-308 may be performed for each machine that is used to participate in a conversation. Thus, each machine may contribute different keywords, which may generate a different selection of ads. (For purposes of the subject matter herein, any two ads may be described as being “distinct” from each other if they are not the same ad.)

At 310, the various ads that are selected may be synchronized, so that the same ad impressions (or different versions of the same ad impression, or different ads that are related to each other) can be shown on the various different machines that participate in the conversation. Synchronization is optional, and different participants in a conversation may opt in or opt out of synchronization. At 312, these ads are provided to the machines, and at 314 they may be displayed on the machines. One example way of displaying the ads on the machines is to show the ads in areas 118 and 120 (shown in FIG. 1). It will be understood that the act of “displaying” an ad includes the situation in which a machine shows the ad on that machine's display. However, it will also be understood that the act of “displaying” an ad includes the situation in which a first machine sends an ad to a second, distinct machine in order to cause the ad to be displayed on that second machine. Thus, when a server sends an ad to a user's machine to be displayed on that user's machine, the server is performing an act of “displaying” the ad.

It is noted that the subject matter herein is described in the context of displaying ads as part of an IM conversation. However, the techniques herein may be used in other ways. Instead of merely displaying ads, information that could be displayed may include weather reports, movie times, or other types of information. (In general, an ad is merely one example of a “content item” that may be displayed.) For example, if the keyword relates to a location and/or to the weather, then the advertisement server could provide a weather report for that location (or for some other location). As another example, if the keyword relates to a movie, then the advertisement server could provide a list of times at which that movie is showing. (FIG. 1, as described above, shows an example in which the name of a theater and the times at which a movie is showing is displayed as an ad. However, basic facts such as movie show times could be provided as general information, irrespective of whether any particular theater has paid for an ad.)

Moreover, the information provided by the advertisement server may be displayed with an IM conversation, but may also be displayed with other types of communications—e.g., video chat, audio chat, etc. (Video chat and/or audio chat may be viewed as a form of, or as a part of, an IM session.) As long as keywords can be detected (which, in the case audio chat, or video chat with an audio feed, could be done through voice recognition), it is possible to determine what ads or other information to serve. Additionally, the technique of having a client identify keywords could be applied to situations other than IM, such as e-mail. In web mail systems, keywords in e-mail that are used to select ads are normally identified by software that runs on the server. But, using techniques described herein, keywords in e-mail (or keywords in other types of information) could be detected on the client.

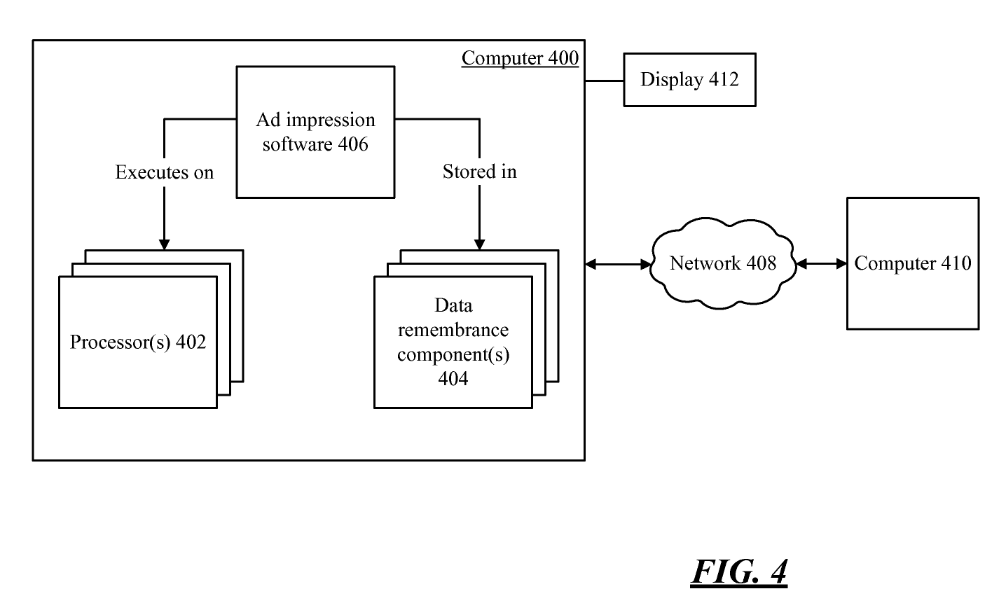

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is ad impression software 406, which may implement some or all of the functionality described above in connection with FIGS. 1-3, although any type of software could be used. Software 406 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 402) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 400 may be communicatively connected to one or more other devices through network 408. Computer 410, which may be similar in structure to computer 400, is an example of a device that can be connected to computer 400, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to present ad impressions with content, wherein the executable instructions, when executed by a computer, cause the computer to perform acts comprising:
receiving content from a conversation;
analyzing said content to identify a keyword in said content, by comparing said content with dictionary of keywords that is stored on said computer on which said executable instructions execute;
sending said keyword to an advertising server, said advertising server being distinct from said computer and being remote to said computer;
receiving, from said advertising server, a first ad to be displayed to a user of said computer, and sending, to participants in said conversation, data that allows ads to be synchronized among said participants; and
displaying said first ad to said user together with said content from said conversation.

2. The one or more computer-readable storage media of claim 1, wherein said conversation comprises an instant messaging (IM) conversation, and wherein said acts further comprise:
displaying said conversation in an IM window, wherein said IM window includes an area in which advertising is displayed; and
displaying said first ad in said area.

3. The one or more computer-readable storage media of claim 2, wherein said keyword relates to weather or to a location, and wherein said acts further comprise:
based on having detected in said content a keyword that relates to weather or to a location, displaying, in said area, a weather report for said location.

4. The one or more computer-readable storage media of claim 2, wherein said keyword relates to a movie, and wherein said acts further comprise:
based on having detected in said content a keyword that relates to said movie, displaying, in said area, a time at which said movie is showing.

5. The one or more computer-readable storage media of claim 1, wherein said conversation comprises an e-mail conversation.

6. The one or more computer-readable storage media of claim 1, wherein said acts further comprise:
receiving, from said advertising server, a second ad that is distinct from said first ad; and
storing said second ad in an ad queue;
wherein said displaying comprises displaying said first ad and said second ad in an order in which said first ad and said second ad are in said queue.

7. A method of presenting ads to users, wherein the method comprises:
using a processor to perform acts comprising:
receiving, from a first machine, a first keyword that has been detected in an instant messaging (IM) conversation in which a first person participates using said first machine, wherein said first keyword is detected by comparing said content with dictionary of keywords that is stored on said first machine;
selecting a first content item based on said first keyword by identifying content that corresponds to said first keyword; and
sending said first content item to said first machine to be displayed to said first person in a window in which said conversation appears, wherein said first machine is configured to send, to participants in said conversation, data that allows said first content to be synchronized among participants in said conversation.

8. The method of claim 7, wherein said first content item comprises an ad, and wherein said selecting comprises:
comparing said first keyword with an ad database; and
identifying said ad in said ad database by determining that said ad corresponds to said first keyword.

9. The method of claim 7, wherein said first keyword relates to weather or to a location, and wherein said first content item comprises a weather report for said location.

10. The method of claim 7, wherein said first keyword relates to a movie, and wherein said first content item comprises a time at which said movie is showing.

11. The method of claim 7, wherein said acts further comprise:
receiving, from a second machine that is distinct from said first machine, a second keyword that has been detected in said instant messaging conversation;
selecting a second content item based on said second keyword, said second content item being distinct from said first content item; and
synchronizing impressions of said first content item and said second content item so that said first machine displays said first content item and said second content item to said first person, and so that said second machine displays said first content item and said second content item to a second person.

12. The method of claim 7, wherein said instant messaging conversation is part of an audio chat session.

13. The method of claim 7, wherein said instant messaging conversation is part of a video chat session.

14. A device for presenting ads to a user, the device comprising:
a processor;
a memory;
a display;
an conversation component through which a user of said device sends and receives messages with one or more participants, wherein said ad impression component sends and receives data with said one or more participants that allows ads to be synchronized between said user and said one or more participants; and
an ad impression component that is stored in said memory and that executes on said processor, wherein said ad impression component detects a first keyword in said messages and sends said first keyword to a server, wherein said ad impression component receives, from said server, a first content item, wherein said ad impression component displays said first content item in a window in which said conversation is displayed.

15. The device of claim 14, wherein said first content item comprises an ad.

16. The device of claim 14, wherein said first keyword relates to weather or to a location, and wherein said first content item comprises a weather report for said location.

17. The device of claim 14, wherein said first keyword relates to a movie, and wherein said first content item comprises a time at which said movie is showing.

18. The device of claim 14, further comprising:
a queue;
wherein said ad impression component receives, from said server, a second content item that is distinct from said first content item, wherein said ad impression component stores said first content item and said second content item in an order in said queue, and displays said first content and said second content item in said window in said order.

19. The device of claim 14, wherein said conversation comprises an audio chat session.

20. The device of claim 14, wherein said conversation comprises a video chat session.
